(19) United States
(12) Patent Application Publication
(10) Pub. No.: US 2003/0235760 A1
(43) Pub. Date: Dec. 25, 2003

(54) Lead-acid storage battery, carbon material and process of manufacturing the carbon material

(75) Inventors: Eiji Hoshi, Hitachi (JP); Kyoko Honbo, Hitachinaka (JP); Yasushi Muranaka, Hitachinaka (JP); Seiji Takeuchi, Hitachioota (JP)

Correspondence Address: CROWELL & MORING LLP, INTELLECTUAL PROPERTY GROUP, P.O. BOX 14300, WASHINGTON, DC, 20044-4300, US

(73) Assignees: Hitachi, Ltd.; Shin-Kobe Electric Machinery Co., Ltd

(21) Appl. No.: 10/390,916

(22) Filed: Mar. 19, 2003

(30) Foreign Application Priority Data
Jun. 19, 2002 (JP) 2002-178577

(51) Int. Cl. C01B 31/00

(52) U.S. Cl. 429/225; 423/414

(57) ABSTRACT

The present invention provides a lead-acid storage battery characterized by excellent characteristics in high percentage charge percentage by improving the conductivity of lead sulfate and its solubility into lead and ensuring smooth charging reaction of anode activator, and a carbon material characterized by excellent chargeability for providing the aforementioned lead-acid storage battery.

A lead-acid storage battery and carbon material thereof characterized in that, in a lead-acid storage battery comprising an anode, cathode and electrolyte, the aforementioned anode contains nickel-supporting carbon wherein metallic nickel and/or nickel-containing compound is supported by carbon, and the diameter of the primary particle of the aforementioned metallic nickel and/or nickel-containing compound is smaller than that of the primary particle of the aforementioned carbon.

### BACKGROUND OF THE INVENTION

1. Field of the Invention

The present invention relates to a lead-acid storage battery, particularly to carbon material for creating a lead-acid storage battery characterized by high percentage charge performances.

2. Prior Art

A lead-acid storage battery is characterized by comparatively low price and a stable performance as a secondary battery, and has therefore been used over an extensive range to provide power for automobiles, portable equipment, computer backup and communications.

In recent years, a recent lead-acid storage battery is required not only to supply power as a main power supply for electric cars, but also to provide a new function as a power supply for starting and recovering regenerative current for hybrid electric cars and simplified hybrid cars.

For these applications, high output performance and high percentage charge performance i.e. high input performance in a short time are especially important.

Many attempts have been made to study the high output performance of a lead-acid storage battery. However, not much improvement has been reached in the high output performance of the lead-acid storage battery.

High percentage charge performance, i.e. high input performance in a short time, largely depends on the characteristics of lead sulfate present on the anode. In the anode activator of the lead-acid storage battery, metallic lead discharges electrons and is changed into lead sulfate in the process of discharging, while lead sulfate obtains electrons and is changed into metallic lead in the process of charging. Lead sulfate generated in discharging is an insulating substance devoid of either ion conductivity or electronic conductivity. The solubility of lead sulfate is very small. As described above, due to poor solubility in addition to extremely poor ion or electronic conductivity, lead sulfate is characterized by a slow reaction from lead sulfate to metallic lead and a low percentage charge performance.

To solve these problems, attempts have been made to improve charge performance for example, by optimizing the amount of carbon added to the anode activator (Japanese Application Patent Laid-Open Publication No. Hei 09-213336) and by addition of metallic tin into the anode activator (Japanese Application Patent Laid-Open Publication No. Hei 05-89873).

### SUMMARY OF THE INVENTION

To improve the high percentage charge performance, the characteristic of lead sulfate must be improved. Firstly, the conductivity of lead sulfate must be increased; secondly, its solubility must be improved.

As disclosed in the Japanese Application Patent Laid-Open Publication No. Hei 09-213336, addition of a proper amount of carbon improves the electronic conductivity and ion conductivity of lead sulfate. For carbon, however, solubility from lead sulfate to lead cannot be improved.

As shown in the Japanese Application Patent Laid-Open Publication No. Hei 05-89873, the conductivity of lead sulfate can be improved in the same manner if metallic tin is contained. However, inclusion of metallic tin fails to improve the solubility from lead sulfate to lead.

One of the objects of the present invention is to provide a lead-acid storage battery characterized by excellent properties of high percentage charge percentage by improving the conductivity of lead sulfate and its solubility into lead and ensuring smooth charging reaction of anode activator.

The other object of the present invention is to provide a carbon material characterized by excellent chargeability and its manufacturing method in order to provide a lead-acid storage battery characterized by excellent properties of high percentage charge percentage by improving the conductivity of lead sulfate and its solubility into lead and ensuring smooth charging reaction of anode activator.

To achieve the aforementioned objects, the present invention proposes a lead-acid storage battery comprising an anode, cathode and battery electrolyte. The anode contains nickel-supporting(carrying) carbon wherein metallic nickel and/or nickel-containing compound is supported(carried) by carbon, and the diameter of the primary particle of said metallic nickel and/or nickel-containing compound is smaller than that of the primary particle of the carbon.

Use of nickel-supporting carbon material having such as a structure improves the high percentage charge performance of a lead-acid storage battery.

The nickel-containing compound is nickel hydroxide and/or nickel oxide.

If the aforementioned nickel-containing compound is nickel hydroxide and/or nickel oxide, the high percentage charge performance of a lead-acid storage battery is further improved.

It is preferred that the ratio of the diameter of the primary particle of the metallic nickel and/or nickel-containing compound to that of the primary particle of the nickel-supporting carbon is between 0.01 and 0.3.

Especially preferred is a small-diameter carbon having a primary particle diameter not exceeding 60 nanometers.

The carbon comprises at least one of acetylene black, furnace black, nanocarbon, graphite, activated carbon and activated carbon fiber.

If the carbon is made of at least one of acetylene black, furnace black, nanocarbon, graphite, activated carbon and activated carbon fiber, high percentage charge performance can be further improved.

The metallic nickel and/or nickel-containing compound is preferred to be spherical.

The amount of the nickel to the carbon in said nickel-supporting carbon is between 0.02 and 0.2 wt %.

To achieve the aforementioned other objects, the present invention proposes carbon material for forming an anode for a lead-acid storage battery comprising an anode, cathode and electrolyte, wherein said carbon material contains the nickel-supporting carbon wherein metallic nickel and/or nickel-containing compound is supported by carbon, and the diameter of the primary particle of the aforementioned metallic nickel material and/or nickel-containing compound is smaller than that of the primary particle of said carbon.

The nickel-containing compound is nickel hydroxide and/or nickel oxide.

The ratio of the diameter of the primary particle of the metallic nickel and/or nickel-containing compound to that of the primary particle of the nickel-supporting carbon is preferred to be between 0.01 and 0.3.

The carbon comprises at least one of acetylene black, furnace black, nanocarbon, graphite, activated carbon and activated carbon fiber.

The metallic nickel and/or nickel-containing compound is preferred to be spherical.

The amount of the nickel to the carbon in said nickel-supporting carbon is between 0.02 and 0.2 wt %.

To achieve the aforementioned other objects, the present invention proposes a method for manufacturing the aforementioned carbon material, wherein said carbon material contains nickel-supporting carbon which supports metallic nickel and/or nickel-containing compound, and the diameter of the primary particle of said metallic nickel and/or nickel-containing compound is smaller than that of the primary particle of said carbon, characterized by comprising:

a step of producing carbon dispersion comprising carbon particles dispersed in water,

a step of adding water-soluble nickel containing salt to the aforementioned carbon dispersion,

a step of dripping aqueous alkali solution into the aforementioned carbon dispersion to have nickel-containing compound be supported on the carbon surface,

a step of separating the aforementioned aqueous carbon solution into solids and aqueous solution, and

a step of heat-treating the aforementioned solids.

The step of producing carbon dispersion contains a step of adding at least one of alcohol, surface-active agent and lignin as a dispersant.

The temperature for heat treatment in the step of heat-treating the aforementioned solids is preferred to be between 290° C. and 330° C.

The high percentage charge performance of a lead-acid storage battery can be further improved if heat treatment temperature is between 290° C. and 330° C. in the step of heat treatment for the production of nickel-supporting carbon.

The present invention minimizes energy loss due to gas generation and further improves high percentage charge performance even when charging with a large current of 2C or more. 2C indicates the current value required to discharge the battery to its full capacity for 0.5 hours. 1C indicates the current value required to discharge the battery to its full capacity for one hour.

The present invention utilizes a strong interaction of nickel with sulfur (S), namely, strong attraction between nickel and sulfur. This characteristic is uses in the reaction of lead sulfate dissociating into sulfuric acid ion and lead ion as an elementary reaction for charging of the anode of a lead-acid storage battery. Sulfuric acid base in sulfuric lead is attracted to the active spot of nickel and is hydrogenated at the same time to be discharged as HSO₄⁻ into electrolyte.

In the case of a lead-acid storage battery, concentration of sulfuric acid in electrolyte is as high as 30 percent by volume, so dissociation cannot be achieved by SO₄²⁻. Dissociation is mostly performed as HSO₄⁻. This shows that dissipation as HSO₄⁻ is important in improving the solubility of lead sulfate.

In the present invention, carbon including metallic nickel and/or nickel-containing compound is added to the anode. Carbon is indispensable for the improvement of conductivity of lead sulfate. However, carbon alone cannot provide sufficient charging performance. This makes it necessary to add nickel capable of catalytic action.

Conversely, addition of metallic nickel and/or nickel-containing compound alone cannot provide conductive effect of carbon, so sufficiently high percentage charge performance cannot be obtained.

To make the most of catalytic action, it is preferred that metallic nickel and/or nickel-containing compound capable of catalytic action be thickly dispersed on carbon as particles with a very small diameter.

Further, nickel-supporting carbon of the present invention contains metallic nickel and/or nickel-containing compound characterized by a high degree of the aforementioned catalytic action. If it is added to the electrolyte of the lead-acid storage battery or surface of the electrode, start of charging can be promoted. Carbon can be attracted to the reaction boundary of the activator. This prevents passivation of lead sulfate that is called “sulfation”. Passivation does not proceed despite complete discharging. Drastic improvement of chargeability is ensured.

As a result, use of the anode according to the present invention provides a lead-acid storage battery applicable to the industrial battery that requires a high level of input characteristics and output characteristics such as electric cars, parallel hybrid electric cars, simplified hybrid cars, power storage systems, elevators, power driven tools, uninterruptible power supply systems and decentralized power supplies.

### BRIEF DESCRIPTION OF THE DRAWINGS

FIG. 1 is a TEM photo representing the first embodiment of a nickel-supporting carbon according to the present invention;

FIG. 2 is a perspective view representing the configuration of a lead-acid storage battery as a first embodiment of the present invention;

FIG. 3 is a diagram representing the relationship between the charging current value and the Ni content (wt %) of the nickel-supporting carbon according to the embodiment 1 of the present invention;

FIG. 4 is a diagram representing the characteristics of the nickel-supporting carbon obtained from Embodiment 2 using various types of carbon;

FIG. 5 is a TEM photo showing the nickel-supporting carbon in Reference Example 2;

FIG. 6 is a diagram representing the relationship between thermal treatment temperatures and charging current value in Embodiment 3 of the present invention;

FIG. 7 is a diagram representing the characteristics of nickel-supporting carbon, gained from Embodiment 4 using various types of carbon;

the diameter of the primary particle of said metallic nickel and/or nickel-containing compound

FIG. 8 is a diagram representing the relationship between the charging current value and the ratio of the diameter of the primary particle of the nickel-containing compound to that of the primary particle of the carbon, in the Embodiment 4 of the present invention;

FIG. 9 is a schematic diagram representing the structure of the nickel-supporting carbon material obtained from the embodiment of the present invention; and

FIG. 10 is a schematic diagram representing the structure of the nickel-supporting carbon material obtained from the Reference Example 2.

### DETAILED DESCRIPTION OF THE INVENTION

(Description of the Preferred Embodiments)

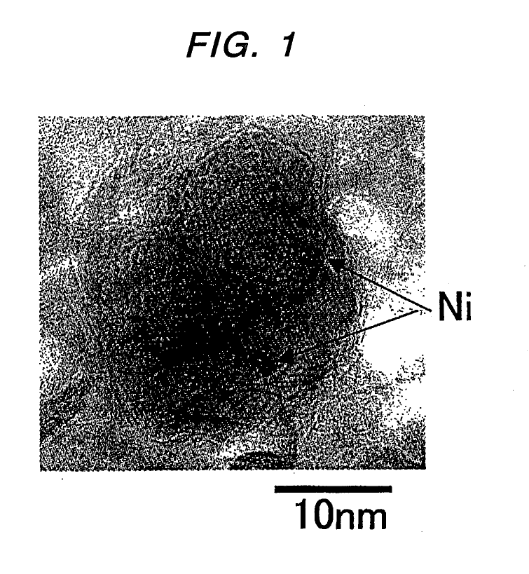

The following describes the lead-acid storage battery, nickel-supporting carbon material and manufacturing method according to the present invention with reference to FIGS. 1 to 10.

[Embodiment 1]

(Manufacturing the Metallic Nickel and/or Nickel-Containing Compound-Supporting Carbon Material)

In manufacturing the metallic nickel and/or nickel-containing compound-supporting carbon material, 10 g of acetylene black as carbon powder and 100 ml of ethanol were put into a pot containing an alumina ball, and were mixed in a ball mill for 24 hours, thereby producing carbon slurry.

This was added to aqueous nickel nitrate solutions of varying concentrations, and was further stirred at 40° C. Then sodium hydroxide was dripped to it, and this solution was filtered. The obtained deposit was washed with distilled water, and was dried at 120° C. for two hours. Then it was burnt for 30 minutes at 300° C. in air to produce a nickel-supporting carbon material.

It has been revealed that NiO is generated by burning in air according to XRD (X-ray diffraction) method. In the X-ray diffraction, the angle and strength are analyzed by changing the angle of X-ray diffraction. This is a test method commonly used for analysis of crystalline structure. Power diffraction method was employed for measurement by X-ray diffraction according to the present invention, and CuKα ray was used as an X-ray source.

ICP analysis (Inductively Coupled Plasma spectrometry) was used to measure the Ni content of carbon material, and it has been shown that the Ni content was 0.005 through 1.5 wt %. The ICP analysis is a highly sensitive method capable of simultaneous detection and quantification of many elements. A specimen was put into an acid solution such as hydrochloric acid or nitric acid that was boiling at 100° C., and was boiled for two through three hours to melt metals. This solution was measured.

A TEM (transmission electron microscope) was used to examine the dispersion of NiO in carbon material. It has been shown that the primary particle of acetylene black has a diameter of 30 through 50 nm. FIG. 1 is a TEM photo representing the first embodiment of a metallic nickel and/or nickel-containing compound-supporting carbon material. As shown in FIG. 1, a plurality of particles attached to NiO are present in a spherical form in the primary particle of carbon having a particle diameter of about 30 nm. It has been confirmed that the primary particle of NiO is smaller than that of the primary particle of carbon.

(Manufacturing an Anode Plate)

In the step of manufacturing an anode plate, 0.3 wt % of lignin, 0.2 wt % of barium sulfate or strontium sulfate, and 0.2 wt % of nickel and/or nickel-containing compound according to the aforementioned method of the present invention are added to lead powder, thereby preparing a mixture obtained by mixing with a kneader for about ten minutes.

Then anode activator paste was formed by kneading 13 wt % of dilute sulfuric acid (with a specific weight of 1.26 at 20° C.) and 12 wt % of water with lead powder. A collector consisting of a grid of lead-calcium alloy was filled with 73 g of this anode activator paste. After it was cured at a temperature of 50° C. and at a relative humidity of 95% for 18 hours, it was left to stand at a temperature of 110° C. for two hours to get dried. In this way, an anode prior to chemical conversion was produced.

(Manufacturing a Cathode Plate)

In the step of manufacturing a cathode plate, cathode activator paste was formed by kneading 13 wt % of dilute sulfuric acid (with a specific weight of 1.26 at 20° C.) and 12 wt % of water with lead powder. Then a collector consisting of a grid of lead-calcium alloy was filled with 85 g of this cathode activator paste. After it was cured at a temperature of 50° C. and at a relative humidity of 95% for 18 hours, it was left to stand at a temperature of 110° C. for two hours to get dried. In this way, a cathode prior to chemical conversion was produced.

(Manufacturing a Battery and Chemical Conversion)

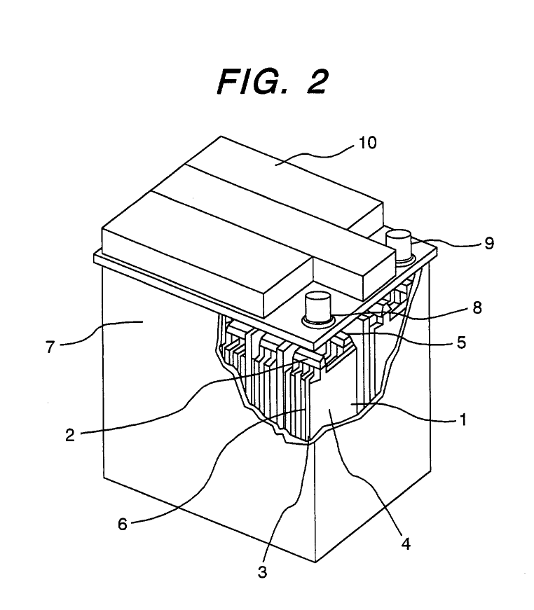

FIG. 2 is a perspective view representing the configuration of a lead-acid storage battery as a first embodiment of the present invention. Six anodes 1 prior to chemical conversion and five cathodes 2 prior to chemical conversion were laminated through a separator 3 composed of glass fiber. Cathodes 2 were connected with each other by cathode strap 5, and anodes 1 were connected with each other by anode strap 6, whereby a polar plate group 4 was manufactured. The polar plate group 4 was arranged inside a battery jar 7. After connection in 18 series, electrolyte of dilute sulfuric acid having a specific weight of 1.05 (at 20° C.) was poured inside to produce a battery prior to chemical conversion.

After this battery prior to chemical conversion had been subjected to chemical conversion by 9A for 42 hours, electrolyte was discharged. Then dilute sulfuric acid electrolyte having a specific gravity of 1.28 (at 20° C.) was again poured therein. The cathode terminal 8 and anode terminal 9 were welded, and were hermetically sealed by a cover 10 provided with an exhaust valve, thereby completing production of a lead-acid storage battery.

The produced battery has a capacity of 18 Ah with an average discharge voltage of 36 volts. Generally, the battery having a discharge voltage of 36 volts and a charging voltage of 42 volts is called a 42-volt battery. If multiple D-size batteries are connected in series, a predetermined voltage can be obtained, and this invention is not restricted to this voltage range.

(High Percentage Charge Performance Test)

In the high percentage charge performance test, the obtained lead-acid storage battery was charged at a constant current and constant voltage for 16 hours using a charging current of 6A and an upper limit voltage of 44.1 volts. Then it was discharged at a discharging current of 4 amperes until 31.5 volts were reached to check the discharge capacity. It was again charged at a charging current of 6A and the upper limit voltage of 44.1 volts for 16 hours. Then 20% of the discharge capacity obtained previously at a discharge voltage of 4 amperes was discharged and charged depth (SOC) was set to 80%. Under this condition, it was left to stand at 40° C. for 20 days. After passivation of lead sulfate called “sulfation”, the battery was charged at a constant current of 70 amperes and constant voltage of 43 volts to obtain a charging current at the fifth second.

Charge voltage rises with the progress of charge reaction, and hydrogen gas is generated from the anode by electrolysis of water. The amount of hydrogen gas generated increases with the rise of charge voltage. Water runs out in the final stage until expiration of service life. Accordingly, charge voltage has an upper limit at the time of charging, and voltage must be kept below the upper limit.

In the battery where high the percentage charge performance is low, voltage rises instantaneous to reach the upper limit if an attempt is made to charge the battery at a large current, and restriction is applied to the flowing current so that voltage does not rise any further. Therefore, the current value is discouraged subsequent to arrival at the upper limit value. In the embodiment of the present invention, the upper limit voltage was set to 43 volts in order to discourage the generation of gas, and the battery was charged at a constant current of 70 amperes and a constant voltage of 43 volts. Evaluation was made from the current value at the fifth second. The charging current value should be higher than 20 amperes, preferably higher than 35 amperes.

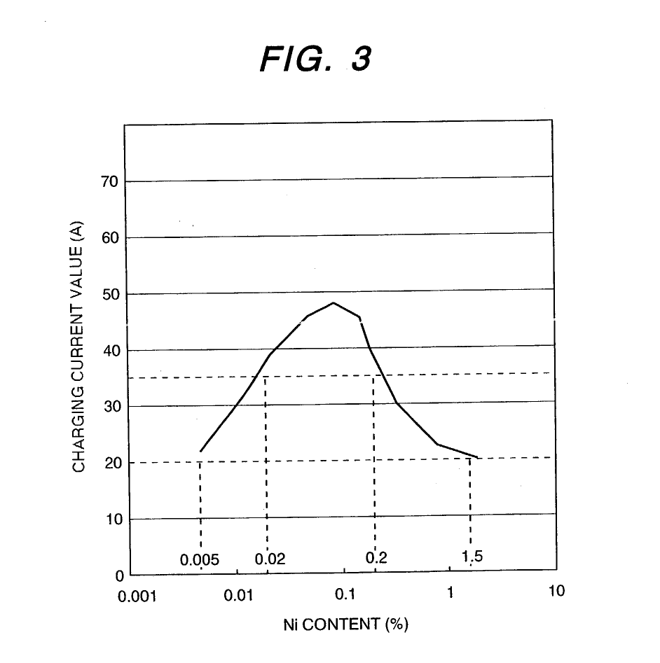

FIG. 3 is a diagram representing the relationship between the charging current value and the Ni content (wt %) of the metallic nickel and/or nickel-containing compound-supporting carbon material according to the embodiment 1 of the present invention. Remarkably good characteristics were exhibited at a high percentage charge performance. When the Ni content is 0.02 wt % to 0.2 wt %, charging current is 35 amperes or more, and the result of high percentage charge performance was still better.

### REFERENCE EXAMPLE 1

Acetylene black without supporting nickel was used to produce a lead-acid storage battery in the same way as Embodiment 1, and high percentage charge performance was evaluated. Charge current was reduced to 5 amperes and it has been revealed that high percentage charge performance is inferior.

[Embodiment 2]

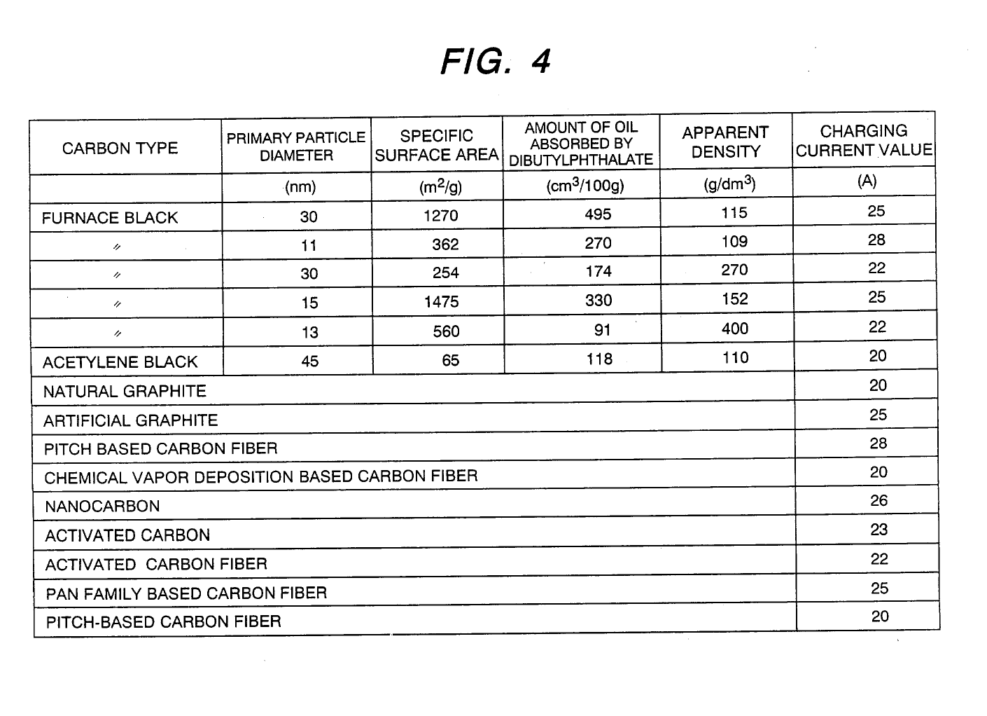

FIG. 4 is a diagram representing the characteristics of the nickel-supporting carbon obtained from Embodiment 2 using various types of carbon. In the production of metallic nickel and/or nickel-containing compound-supporting carbon material, various types of carbon shown in FIG. 4 was used as carbon powder, and metallic nickel and/or nickel-containing compound-supporting carbon material was produced in the same manner as Embodiment 1.

A lead-acid storage battery was produced in the same manner as Embodiment 1 to evaluate the high percentage charge performance. FIG. 4 shows the charging current value. In any of carbon materials, charging current value was higher than 20 amperes, and good characteristics were recorded in high percentage charge performance. Further, when these types of carbon were mixed, charging current value was higher than 20 amperes, and good characteristics were also recorded in high percentage charge performance in the similar manner.

### REFERENCE EXAMPLE 2

In the production of metallic nickel and/or nickel-containing compound-supporting carbon material, a predetermined nickel nitrate solution was produced, and 10 g of acetylene black was added to it as carbon powder. It was then agitated in a water reservoir at 10° C. This solution was filtered and the obtained deposit was washed by distilled water. After having been dried at 120° C. for two hours, it was baked in air at 300° C. for 30 minutes to produce a nickel-supporting carbon material. It was found out by XRD that NiO was generated by baking in air.

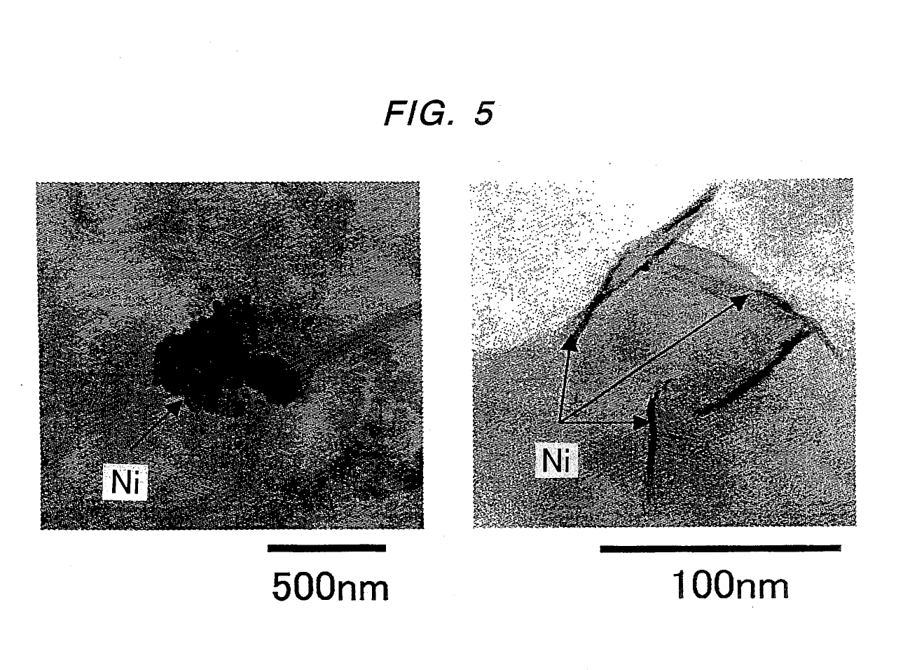

A TEM (transmission electron microscope) was used to examine the dispersion of NiO in carbon material. FIG. 5 is a TEM photo showing the metallic nickel and/or nickel-containing compound-supporting carbon material in Reference Example 2. As shown in FIG. 5, it was verified that about 500 nm of NiO coagulated particles and about 100 nm needle crystal were present, and the primary particle of NiO larger than that of carbon was present. A lead-acid storage battery was produced in the same-manner as Embodiment 1 to evaluate the high percentage charge performance. Charging current dropped to 5 amperes, indicating that the high percentage charge performance was degraded.

[Embodiment 3]

In the production of metallic nickel and/or nickel-containing compound-supporting carbon material, thermal treatment was performed at 200 through 350° C., and metallic nickel and/or nickel-containing compound-supporting carbon material was produced in the same manner as Embodiment 1.

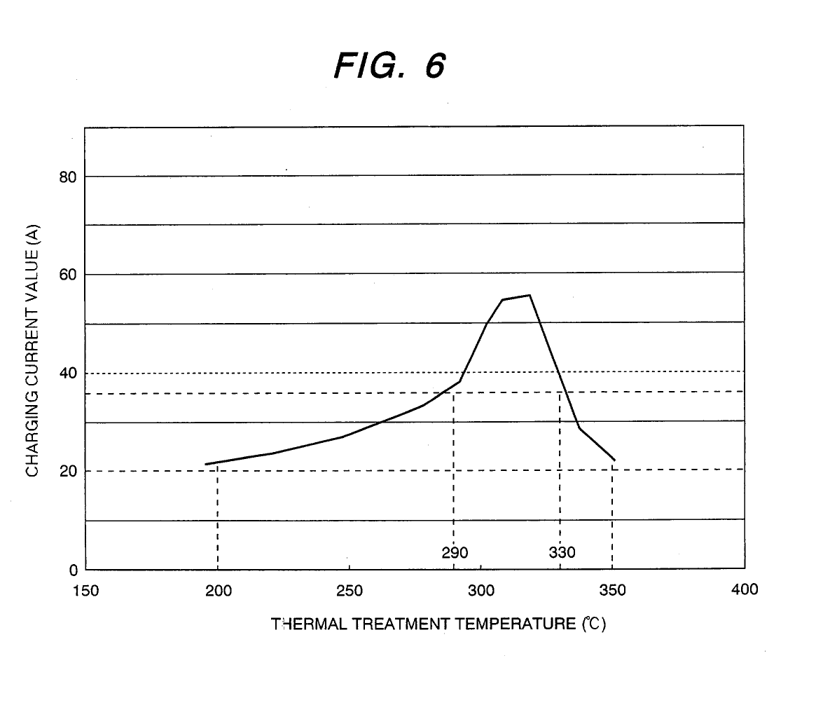

Similarly to the case of Embodiment 1, a lead-acid storage battery was manufactured to evaluate the high percentage charge performance. FIG. 6 is a diagram representing the relationship between thermal treatment temperatures and charging current value in Embodiment 3 of the present invention. In any of the examples, the charging current value was higher than 20 amperes and the result of high percentage charge performance was excellent. Especially in a temperature from 290 through 330° C., charging current value was higher than 35 amperes and it was verified that the result of high percentage charge performance was excellent.

[Embodiment 4]

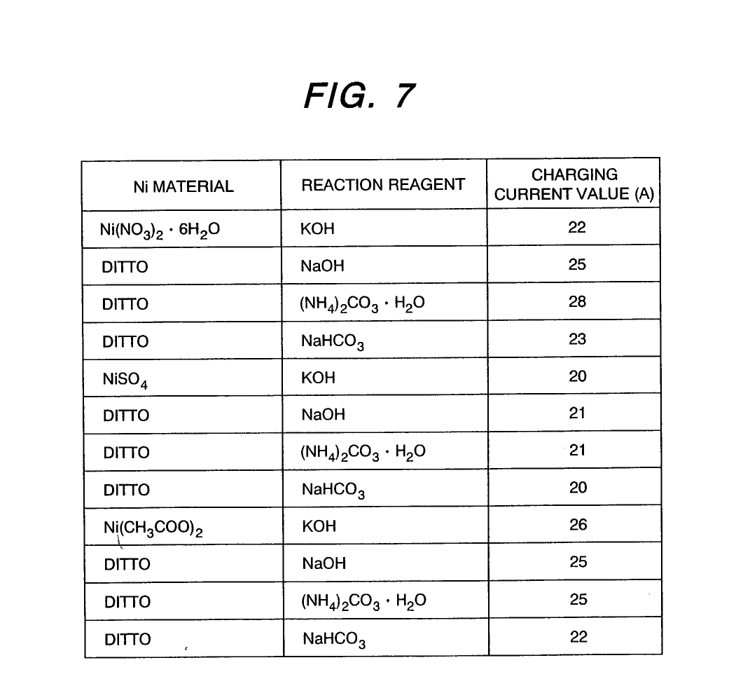

FIG. 7 is a diagram representing the characteristics of nickel-supporting carbon material, gained from Embodiment 4 using various types of carbon. In the production of metallic nickel and/or nickel-containing compound-supporting carbon material, aqueous nickel material solution shown in FIG. 7 was prepared and 10 g of acetylene black was added to it as carbon powder. 0.5 g of lignin or surface active agent was added to it as dispersant, and was agitated in a water tank at 40° C.

Reaction reagent given in FIG. 7 was dripped, and the deposit obtained by filtering this solution was washed with distilled water. After having been dried at 120° C. for two hours, it was baked in air and hydrogen at 300° C. for 30 minutes to produce a metallic nickel and/or nickel-containing compound-supporting carbon material.

The nickel members were detected by XRD to contain metallic nickel, nickel hydroxide, nickel oxide and the mixture thereof.

A TEM (transmission electron microscope) was used to examine the dispersion of nickel members in carbon material. In any case, multiple NiO-attached particles were present in spherical form, and the primary particle of NiO was confirmed to be smaller than that of carbon.

Similarly to the case of Embodiment 1, a lead-acid storage battery was manufactured to evaluate the high percentage charge performance. FIG. 7 shows the charging current value. In any case, charging current value was higher than 20 amperes, and the result of high percentage charge performance was excellent.

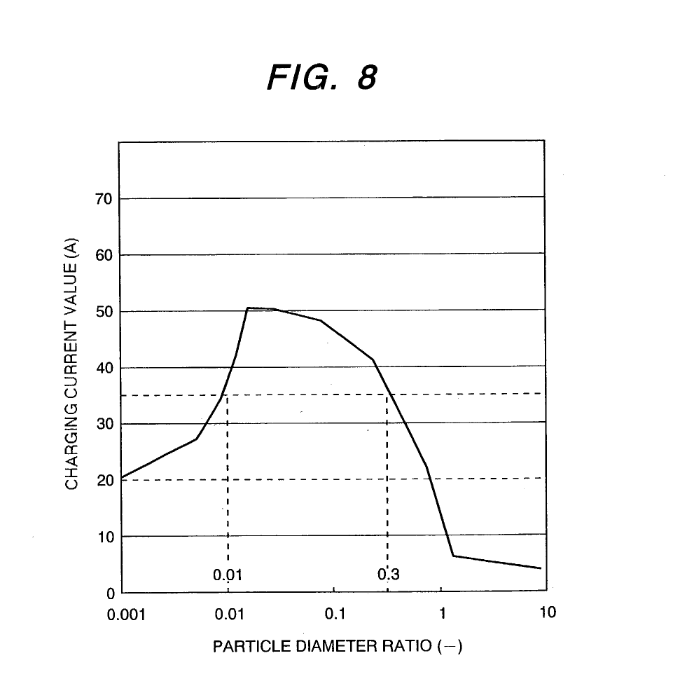

FIG. 8 is a diagram representing the relationship between the charging current value and the ratio of the diameter of the primary particle of the metallic nickel and/or nickel-containing compound to that of the primary particle of the carbon, in the Embodiment 4 of the present invention. It was verified that, when the particle diameter ratio was in the range from 0.01 through 0.3, the charging current value was higher than 36 amperes, and the result of high percentage charge performance was excellent.

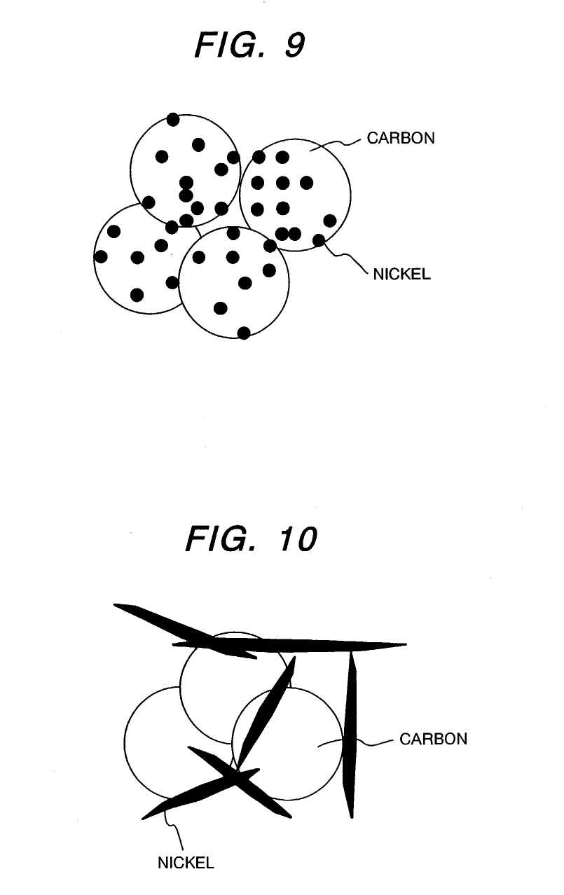

FIG. 9 is a schematic diagram representing the structure of the nickel-supporting carbon material obtained from the embodiment of the present invention.

FIG. 10 is a schematic diagram representing the structure of the nickel-supporting carbon material obtained from the Reference Example 2.

In the metallic nickel and/or nickel-containing compound-supporting carbon material of the present invention, the diameter of the primary particle of the nickel member is smaller than that of the primary particle of carbon, as is apparent from the comparison between FIGS. 9 and 10. The catalytic activity of the nickel member is very high. This carbon material is left to stand at 40° C. for 20 days. Even when it is covered with a passive film of lead sulfate called “sulfation”, lead sulfate can be easily dissolved with nickel member as a kernel, thereby responding to quick charging reaction.

(Effects of the Invention)

The present invention provides a lead-acid storage battery characterized by excellent percentage charge performance and a carbon material for lead-acid storage battery.

What is claimed is

1. A lead-acid storage battery comprising an anode, cathode and battery electrolyte, said lead-acid storage battery being characterized in that:
said anode contains nickel-supporting carbon wherein metallic nickel and/or nickel-containing compound is supported by carbon, and
the diameter of the primary particle of said metallic nickel and/or nickel-containing compound is smaller than that of the primary particle of said carbon.

2. A lead-acid storage battery according to claim 1, characterized in that:
said nickel-containing compound is nickel hydroxide and/or nickel oxide.

3. A lead-acid storage battery according to claim 1, characterized in that:
the ratio of the diameter of the primary particle of said metallic nickel and/or nickel-containing compound to that of the primary particle of said nickel-supporting carbon is between 0.01 and 0.3.

4. A lead-acid storage battery according to claim 1, characterized in that:
said carbon comprises at least one of acetylene black, furnace black, nanocarbon, graphite, activated carbon and activated carbon fiber.

5. A lead-acid storage battery according to claim 1, characterized in that:
said metallic nickel and/or nickel-containing compound is spherical.

6. A lead-acid storage battery according to claim 1, characterized in that:
the amount of the nickel to the carbon in said nickel-supporting carbon is between 0.02 and 0.2 wt %.

7. A carbon material for forming an anode of the lead-acid storage battery comprising said anode, cathode and electrolyte, said carbon material characterized in that:
said carbon material contains nickel-supporting carbon wherein metallic nickel and/or nickel-containing compound is supported by carbon; and
the diameter of the primary particle of said metallic nickel and/or nickel-containing compound is smaller than that of the primary particle of said carbon.

8. A carbon material according to claim 7, characterized in that:
said nickel-containing compound is nickel hydroxide and/or nickel oxide.

9. A carbon material according to claim 7, characterized in that:
the ratio of the diameter of the primary particle of said metallic nickel and/or nickel-containing compound to that of the primary particle of said nickel-supporting carbon is between 0.01 and 0.3.

10. A carbon material according to claim 7, characterized in that:
said carbon comprises at least one of acetylene black, furnace black, nanocarbon, graphite, activated carbon and activated carbon fiber.

11. A carbon material according to claim 7, characterized in that:
said metallic nickel and/or nickel-containing compound is spherical.

12. A carbon material according to claim 7, characterized in that:
the amount of the nickel to the carbon in said nickel-supporting carbon is between 0.02 and 0.2 wt %.

13. A method for manufacturing the carbon material, wherein said carbon material contains nickel-supporting carbon which supports metallic nickel and/or nickel-containing compound, and the diameter of the primary particle of said metallic nickel and/or nickel-containing compound is smaller than that of the primary particle of said carbon, comprising:
a step of producing carbon dispersion comprising carbon particles dispersed in water,
a step of adding water soluble nickel containing salt to said carbon dispersion,
a step of dripping aqueous alkali solution into said carbon dispersion to have nickel-containing compound be supported on the carbon surface,
a step of separating said carbon dispersion into solids and aqueous solution, and
a step of heat-treating said solids.

14. A method for manufacturing the carbon material according to claim 13, characterized in that:
said step of producing carbon dispersion contains a step of adding at least one of alcohol, surface-active agent and lignin as a dispersant.

15. A method for manufacturing the carbon material according to claim 13, characterized in that:
temperature for heat treatment in the step of heat treating said solids is between 290° C. and 330° C.
